(19) United States
(12) Patent Application Publication
(10) Pub. No.: US 2021/0308941 A1
(43) Pub. Date: Oct. 7, 2021

(54) ADDITIVELY MANUFACTURING A 3D OBJECT INCLUDING A SECOND MATERIAL

(71) Applicant: HEWLETT-PACKARD DEVELOPMENT COMPANY, L.P., Houston, TX (US)

(72) Inventors: Kristopher J. ERICKSON, Palo Alto, CA (US); Sterling CHAFFINS, Corvallis, OR (US); Howard S. TOM, Palo Alto, CA (US)

(73) Assignee: HEWLETT-PACKARD DEVELOPMENT COMPANY, L.P., Houston, TX (US)

(21) Appl. No.: 16/077,666

(22) PCT Filed: Apr. 17, 2017
(86) PCT No.: PCT/US2017/027870

§ 371 Date: Aug. 13, 2018

(51) Int. Cl. B29C 64/165; B33Y 10/00; B33Y 30/00; B29C 64/205; B29C 64/277; B28B 1/00; B22F 10/10; B22F 12/45; B22F 12/50

(52) U.S. Cl. CPC B29C 64/165; B33Y 10/00; B33Y 30/00; B29C 64/205; B33Y 50/02; B28B 1/001; B22F 10/10; B22F 12/45; B22F 12/50; B29C 64/277

(57) ABSTRACT

A 3D printer to additively manufacture a 3D object includes a coater, a dispenser, and an energy source. The coater is to coat a first material relative to a print bed to form a selectable number of first layers. The dispenser is to dispense a first fluid agent onto first selected locations of the first layers of the first material. The energy source is to cause fusing at the first selected locations. The dispenser is to also dispense a second fluid agent including a second material to form a selectable number of second layers of the second material at second selected locations on top of the selectable number of first layers. Each second selected location comprises at least some of the fused first selected locations.

### BACKGROUND

Additive manufacturing may revolutionize design and manufacturing in producing three-dimensional (3D) objects. Some forms of additive manufacturing may sometimes be referred to as 3D printing. Some additively manufactured 3D objects may have functional characteristics, such as mechanical or electrical utility, while other 3D objects may simply be made for aesthetic purposes.

### BRIEF DESCRIPTION OF THE DRAWINGS

FIG. 1A is a diagram including a top view schematically representing an example device for additively manufacturing a 3D object.

FIG. 1B is a diagram including an isometric view schematically representing a partially formed example 3D object.

FIG. 1C is a diagram including a top view schematically representing an example group of voxels.

FIGS. 2A-2B are each an enlarged partial sectional view schematically representing formation of an example structure, using a second material, of a partially formed example 3D object.

FIG. 3A is a side view schematically representing a formed example structure of a second material.

FIG. 3B is a partial sectional view schematically representing a formed example structure of a partially formed example 3D object.

FIG. 4 is a sectional view schematically representing example formation of a layer of first material relative to a partially formed example 3D object.

FIG. 5 is a sectional view schematically representing at least a portion of an example 3D object.

FIG. 6 is a sectional view schematically representing at least a portion of an example 3D object.

FIG. 7A is a sectional view schematically representing at least a portion of an example 3D object including at least an embedded structure of at least one second material.

FIG. 7B is a diagram including a top view schematically representing an example pattern of voxels of an example 3D object.

FIG. 7C is a side view schematically representing at least a portion of an example 3D object including an embedded structure of at least one second material.

FIG. 7D is a side view schematically representing at least a portion of an example 3D object including an embedded structure of at least one second material.

FIG. 8A is a block diagram schematically representing an example control portion.

FIG. 8B is a block diagram schematically representing an example user interface.

FIG. 9 is a block diagram schematically representing an example print engine.

FIG. 10 is a flow diagram schematically representing an example method of additive manufacturing.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure involve additively manufacturing a 3D object using both a first material and a second material different than the first material.

In some examples, a 3D printer for additively manufacturing a 3D object comprises a coater, a dispenser, and an energy source. The coater coats a first material relative to a print bed to form a selectable number of first layers while the dispenser dispenses a first fluid agent onto first selected locations of the first layers of the first material. The energy source causes fusing at least at the first selected locations. The dispenser dispenses a second fluid agent including a second material to form a selectable number of second layers of the second material at second selected locations on top of the selectable number of first layers, wherein each second selected location comprises at least some of the fused first selected locations.

In some examples, additional first layers of the first material are formed which at least surround a structure formed of the second material at the second selected locations. In some examples, additional first layers may be laid over the structure so as to completely embed the structure of second material within the 3D object.

When forming layers of a 3D object via this arrangement, the second material is dispensed at the second selected locations to pre-emptively prevent later placement of the first material at the second selected locations. Accordingly, in one sense at the second selected locations, the second material replaces first material which would have otherwise occupied the second selected locations. In this way, material properties of the second material, which are different than the material properties of the first material, may be implemented strategically at desired locations within a 3D object. The different material properties of the second material may be electrical, mechanical, magnetic, optical, thermal, etc. A single second material or multiple different second materials may be employed. As noted above, the second material(s) may be deposited as part of a second fluid agent, such as a fluid ink.

In some examples, this arrangement enables making a 3D object in which a coater applies layers of a single first material to generally form a bulk of the 3D object while using a single dispenser to both deposit fusing agents for the single first material and deposit layers of a second material as a substitute for the first material at some locations within or on the 3D object. In other words, without disrupting the application of the single first material via the coater, the dispenser can deposit a second material in layers so that the 3D object may be formed of different materials having different material properties.

In some examples, such an arrangement may eliminate use of two different second additive manufacturing technologies (as is found in some commercially available 3D printers) in order to incorporate a second material into a 3D object.

Accordingly, via this arrangement, a device for additively manufacturing a 3D object may selectively vary the material properties of portions of the 3D object, which may enhance a range of functionality, performance, and/or appearance of the 3D object.

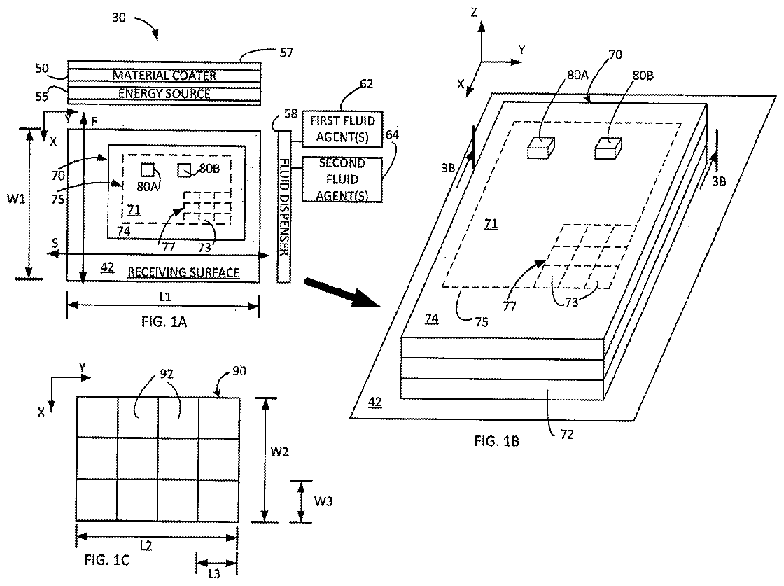

These examples, and additional examples, are described and illustrated in association with at least FIGS. 1A-10.

FIG. 1A is a diagram schematically representing an example device 30 for additively manufacturing an example 3D object. As shown in FIG. 1A, in some examples, the device 30 includes a material coater 50, an energy source 55, and a fluid dispenser 58.

The material coater 50 is arranged to coat a first material layer-by-layer onto a receiving surface 42 to additively form a 3D object 70 shown in FIG. 1B. It will be understood that a 3D object of any shape can be manufactured, and the object 70 depicted in FIG. 1B provides just one example shape of a partially formed 3D object. In some instances device 30 may sometimes be referred to as a 3D printer. Accordingly, the receiving surface 42 may sometimes be referred to as a print bed.

It will be understood that the coater 50 may be implemented via a variety of mechanical mechanisms, such as doctor blades, slot dies, and/or other structures suitable to spread and/or otherwise form a coating of the first material in a generally uniform layer relative to the receiving surface 42 or a previously deposited layer of first material.

In some examples, the material coater 50 has a length (L1) at least generally matching an entire length (L1) of the receiving surface 42, such that the material coater 50 is capable of coating the entire receiving surface 42 with a first layer of first material in a single pass as the material coater 50 travels the width (W1) of the receiving surface 42. In some examples, the material coater 50 can selectively deposit layers of material in lengths and patterns less than a full length of the material coater 50. In some examples, the material coater 50 may coat the receiving surface 42 with a first layer of first material(s) using multiple passes instead of a single pass.

It will be further understood that a 3D object additively formed via device 30 may have a width and/or a length less than a width (W1) and/or length (L1) of the receiving surface 42. Once formed, the 3D object is separate from, and independent of, the receiving surface 42.

In some examples, the material coater 50 moves in a first orientation (represented by directional arrow F) while the fluid dispenser 58 moves in a second orientation (represented by directional arrow S) generally perpendicular to the first orientation. In some examples, the material coater 50 can deposit material in each pass of a back-and-forth travel path along the first orientation while the fluid dispenser 58 can deposit fluid agents in each pass of a back-and-forth travel path along the second orientation. In at least some examples, one pass is completed by the material coater 50, followed by a pass of the fluid dispenser 58 before a second pass of the material coater 50 is initiated, and so on.

In some examples, the material coater 50 and the dispenser 58 can be arranged to move in the same orientation, either the first orientation (F) or the second orientation (S). In some examples, the material coater 50 and the dispenser 58 are supported and moved via a single carriage while in some examples, the material coater 50 and dispenser 58 may be supported and moved via separate, independent carriages.

In some examples, the first material used to generally form the 3D object comprises a polymer material. In some examples, the first material may comprise a ceramic material. In some examples, the first material may take the form of a powder while in some examples, the first material may take a non-powder form. Regardless of the particular form, the first material is suitable for spreading, depositing, etc. in a flowable form to produce a coating (via coater 50) relative to receiving surface 42 and/or relative to previously coated first layers of the first material. In some examples, the first material acts as a build material which does not significantly exhibit electrical properties, optical properties, magnetic properties, etc. However, if desired, at least some of these various properties may be infused into the first material to at least some degree via a first fluid agent, as later described below in more detail in association with at least FIG. 1A and FIG. 9. Moreover, in some examples, a first material may already incorporate at least some of these properties prior to employing the first material in forming the 3D object. In some examples, the build material may even comprise an electrically insulative material or a semi-conductive material.

In some examples, the fluid dispenser 58 shown in FIG. 1A comprises a printing mechanism, which comprises an array of printheads, each including a plurality of individually addressable nozzles for selectively ejecting agents onto a first layer of first material. Accordingly, in some examples, the fluid dispenser 58 may sometimes be referred to as an addressable fluid ejection array. In some examples, the fluid dispenser 58 may eject individual droplets having a volume on the order of ones of picoliters or on the order of ones of nanoliters.

In some examples, fluid dispenser 58 comprises a thermal inkjet (TIJ) array. In some examples, fluid dispenser 58 may comprise a piezoelectric inkjet (PIJ) array or other technologies such as aerosol jetting, anyone of which can precisely, selectively deposit a small volume of fluid. In some examples, fluid dispenser 58 may comprise continuous inkjet technology.

In some examples, the fluid dispenser 58 selective dispenses droplets on a voxel-by-voxel basis. In some examples, a resolution of 1200 voxels per inch is implemented via fluid dispenser 58. In one sense a voxel may be understood as a unit of volume in a three-dimensional space.

In some examples, the fluid dispenser 58 has a width (W1) at least generally matching an entire width (W1) of the receiving surface 42, and therefore may sometimes be referred to as providing page-wide manufacturing (e.g. page wide printing). In such examples, via this arrangement the fluid dispenser 58 can deposit fluid agents onto the entire receiving surface in a single pass as the fluid dispenser 58 travels the length (L1) of the receiving surface 42. In some examples, the fluid dispenser 58 may deposit fluid agents onto a given layer of material using multiple passes instead of a single pass.

After forming one of the first layers of the first material, in some examples the dispenser 58 may selectively dispense droplets of a first fluid agent at first selected locations of an uppermost layer of first material. The particular example 3D object shown in FIG. 1A involves a group 71 of first selected locations 73 having a generally rectangular shape (as represented via dashed line 75). However, for illustrative clarity, at 77 FIG. 1A depicts just some of the first selected locations 73 of group 71. Meanwhile, the area 74 external to the group 71 of first selected locations 73 (i.e. external to dashed line 75) ultimately will be discarded and not form part of a final 3D object.

It will be understood that a group 71 of first locations 73, or multiple different groups 71 of first locations 73, may be selected in any size and/or shape, such as circular, ring, etc. In some examples, a group of first selected locations may form even more complex shapes, such as a gear, a chain link, an impeller, just to name a few of many different types of components and/or articles.

Similarly, while formation of structures 80A-80B is described later, it will be further understood that the size, quantity, and/or shape of structures 80A-80B as shown in FIG. 1A-1B are merely representative and that other sizes, quantities, and/or shapes of structures may be implemented.

With reference to FIG. 1C, it will be understood that in some examples, each first selected location 73 in FIGS. 1A-1B may correspond to a group 90 of single voxels 92 while in some examples, each first selected location 73 may correspond to a single voxel 92. In the latter example, group 90 of voxels 92 in FIG. 1C would correspond to a group of first selected locations. For instance, the example group 90 of voxels 92 may have a width W2 and a length L2 while each individual example voxel 92 may have a width W3 and a length L3.

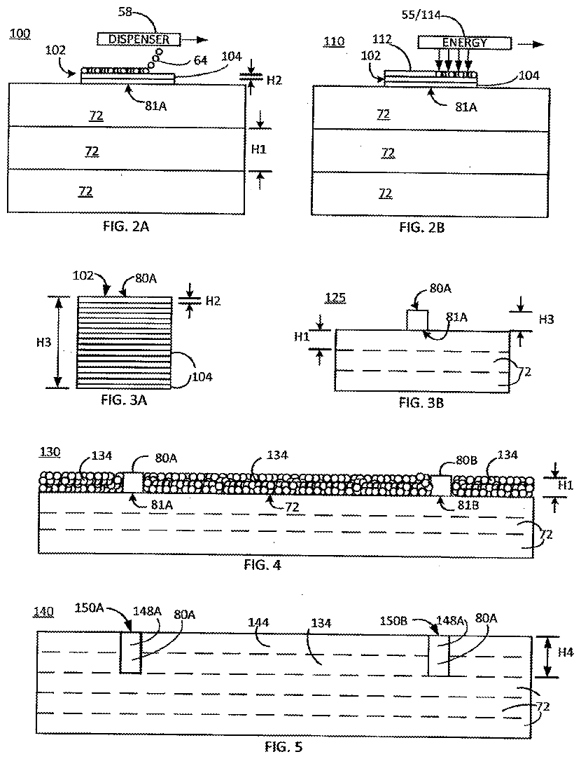

As later described more fully in association with at least FIGS. 2A-3B, each second selected location (at which a second fluid agent is deposited) at which a respective structure 80A, 80B (FIGS. 1A-1B) is formed also may correspond to a single voxel 92 or a group 90 of voxels 92 as represented in FIG. 1C. It will be understood that any first selected location (or second selected location) comprising a group of voxels is not limited to the rectangular shape and/or size shown in FIGS. 1C and 1s not limited to the number of voxels shown in FIG. 1C.

As further shown in FIG. 1A, fluid dispenser 58 may comprise, or be in fluid communication with, an array of reservoirs to contain various fluid agents, such as but not limited to, a first fluid agent 62 and a second fluid agent 64. Second fluid agent 62 will be further described later in association with at least FIGS. 2A-2B. In some examples, the first fluid agent 62 may comprise a fusing agent, detailing agent, etc. to facilitate formation of each first layer 72 of first material. In particular, upon application onto the first material at first selected locations via the dispenser 58, the respective fusing agent and/or detailing agent may diffuse, saturate, and/or blend into a first layer of the first material at the first selected locations.

As further shown in FIG. 1, device 30 includes an energy source 55 for irradiating the deposited materials, first fluid agents, etc. to cause heating of the material, which in turn results in the fusing of particles of the material relative to each other, with such fusing occurring via melting, sintering, etc. After such fusing, a first layer of first material is completely formed and additional first layers 72 of first material may be formed in a similar manner.

In some examples, the energy source 55 may comprise a gas discharge illuminant, such as but not limited to a Halogen lamp. In some examples, the energy source 55 may comprise multiple energy sources. A first energy source may cause fusing of the first material to form first layers 72 at the first selected locations. However, a second energy source (e.g. 114 in FIG. 2B) may selectively cure or dry the second fluid agent without otherwise affecting the previously fused first material, as later described in association with at least FIG. 2B.

As previously noted, energy source 55 and/or energy source 114 (FIG. 2B) may be stationary or mobile and may operate in a single flash or multiple flash mode.

As further shown in FIGS. 1A-1B, the partially formed 3D object also comprises structures 80A, 80B on top of the uppermost first layer 72 of first material with structures 80A, 80B being formed of a second material. Structures 80A, 80B, and their formation, will be further described below in association with at least FIGS. 2A-3B.

In some examples the device 30 can be used to additively form a 3D object via a MultiJet Fusion (MJF) process (available from HP, Inc.). In some examples, an additive manufacturing process performed via device 30 may omit at least some aspects of and/or may include at least some aspects of: selective laser sintering (SLS); selective laser melting (SLM); 3D binder printing (e.g. 3D binder jetting); fused deposition modeling (FDM); stereolithography (SLA); or curable liquid photopolymer jetting (Polyjet).

With these general components of device 30 in mind, one example formation of partially formed example 3D object 70 is described.

As shown in FIG. 1A, device 30 manufactures 3D object by forming a selectable number of first layers 72 of a first material, such as one of the above-described build materials. This formation includes using material coater 50 to coat the receiving surface 42 (or a preceding layer 72) with a layer 72 of the first material and then applying a first fluid agent 62 via dispenser 58 at selected locations (i.e. first selected locations) on the current layer 72. Irradiation of these first selected locations by the energy source 55 results in fusing of the first material, fusing agents, detailing agents, etc. This cycle of coating, dispensing and fusing is repeated until the selected number of first layers 72 of the first material is formed as shown in at least FIG. 1B.

After the selectable number of first layers 72 is formed, and as shown in FIG. 2A, the fluid dispenser 58 dispenses a second fluid agent 64 at some of the first selected locations, which may sometimes then be referred to as second selected locations 81A, 81B. In the example depicted in FIGS. 1A-1B, these second selected locations 81A, 81B correspond to the position of structures 80A, 80B on the uppermost first layer 72.

In some examples, the second fluid agent 64 may comprise at least one second material having at least one material property different than the material properties of the first material which forms the first layers 72. This second material(s) forming second structure 80A, 80B may exhibit a wide range of properties as controllable via dispenser 58 (FIG. 1A) and/or print engine 500 as later described in detail in association with FIG. 9. For instance, at least some of these different properties involve electrical, mechanical, magnetic, optical, and thermal parameters (e.g. 552, 554, 556, 562, 564, 566, 572, 574, 576, 578, etc.), as described in more detail in association with at least FIG. 9. In some examples, the second material comprises multiple different second materials each exhibiting different properties. In some examples, a single second material may exhibit multiple properties which differ from the material properties of the first material forming first layers 72.

As just one example, the second material may comprise an electrically conductive material and the first material in the first layers comprises a generally electrically non-conductive material. In some examples, this electrically conductive second material comprises a silver nanoparticle material.

In some examples, the second material in the second fluid agent may comprise an electrically conductive material, which is the same material as the first material in the first fluid agent. Accordingly, in such examples, the first material may comprise an electrically conductive material. In some such examples, the first material and second material comprise a metal material, such as silver nanoparticles from a silver nanoparticle ink. In some examples, the first and second materials comprise a black material or other color suited to enhance absorption of energy applied via an energy source (e.g. 55 and/or 114). In such examples, when deposited the first material becomes diffused into the build material at the voxel at which the first fluid agent (including the first material) is deposited, such the relative electrical conductivity of the first material is relatively small compared to the second material which, when applied in layers (as further described later), does not become diffused into the build material. In such examples, when diffused into the build material of the first layers (e.g. 72 in FIG. 1B) and acting as a first material, the material may act as a fusing agent while the same material when acting as a second material (deposited via the second fluid agent), may form a high electrical conductivity element (e.g. FIGS. 2A-3B). In this way, the same material may be used as a first material (in the first fluid agent) and as a second material (in the second fluid agent) to achieve different purposes.

As shown in FIG. 2B, in some examples energy source 114 is used to dry the second fluid agent 64 and expedite formation of structure comprising a group 102 of layers 104 of solids of the second material(s). In some examples, energy source 114 comprises the same energy source 55 used to cause fusing of first fluid agent and first material. However, in some examples, the energy source 114 comprises a second energy source different than energy source 55 with energy source 114 being able to selectively apply energy preferentially and/or exclusively to the second selected locations 81A, 81B to expedite drying the second material without unnecessarily heating first selected locations 73 other than the second selected locations 81A, 81B. Accordingly, in some examples, the energy source 114 may comprise an illuminant having an emission spectrum such that the optical absorption properties at the second selected locations (i.e. location to form structures 80A, 80B) results in preferential heating at those locations while the optical absorption properties at other locations on the first material results in little to no heating. In some examples, the energy source 114 may comprise a gas discharge illuminant, a flashlamp, an ultraviolet (UV) lamp, or LED lamp. In some examples, the energy source 114 may comprise a laser.

Upon drying each batch of deposited second fluid agent, the solids of the second material form layers 104 at the second selected locations 81A, 81B.

This dispensing of the second fluid agent 64 is repeated until a selectable number of second layers 104 of the second material are formed. As shown in FIGS. 2A and 3A-3B, each of these second layers 104 has height H2 substantially less than a height H1 of first layers 72. In some examples, the height H2 of a second layer 104 may be at least one order of magnitude less than the height H1 of a first layer 72. In some examples, height H1 may be about 80 to about 100 microns while in some examples, height H2 may be about 3 microns, although height H2 may be between 1 to 10 microns.

However, upon forming a sufficient (selectable) number of such second layers 104, a structure 80A, 80B of the second material is formed having a height H3 as shown in FIGS. 3A-3B. In some examples, the height H3 of structure 80A is generally the same as a height H1 of the first layers 72. In some examples, this height H3 is the height of a voxel. In some examples, the height H3 is greater than a height H1 of the first layers 72 of first material. In the examples in which height H1 comprises about 80 to about 100 microns, the height H3 may be about at least 80 to about at least 100 microns.

In a manner consistent with the features and attributes as previously noted in association with at least FIG. 1C, it will be understood that each structure 80A, 80B may correspond to a single voxel 92 in some examples, and may correspond to a group 90 of voxels 92 in the x-y plane in other examples.

In some examples, the second material may comprise an electrically conductive material. In some examples, the structure 80A, 80B exhibits at least a 50 percent fraction of conductive material relative to the first material, such as a generally electrically non-conductive build material. In other words, 50 percent of the total volume of material forming the structure 80A, 80B comprises a purely electrically conductive material, such as silver. In some examples, the structure 80A, 80B exhibits at least a 75 percent fraction of conductive material relative to the first material. In some examples, the structure 80A, 80B exhibits at least a 90 percent fraction of conductive material relative to the first material. In some examples, the second fluid agent comprises an 8:1 ratio of a silver nanoparticle ink relative to an ink carrier (i.e. ink vehicle). It will be understood that various types and mixtures of ink fluxes may be used as the ink carrier.

In some examples, the first material of first layers 72 may exhibit minor or negligible electrical conductivity and the electrical conductivity of the structure(s) 80A, 80B may be at least one order of magnitude greater than the electrical conductivity of the first material in first layers 72. In some such examples, the electrical conductivity of the structure(s) 80A, 80B may be at least two orders of magnitude greater than the electrical conductivity of the first material of first layers 72.

In some examples, a composite of the first material and the first fluid agent in the first layers 72 comprises an electrical conductivity of about 1/6000th (i.e. 0.000167) of the electrical conductivity of bulk silver. Meanwhile, in some examples, the structure 80A, 80B formed of the second material exhibits an electrical conductivity of about 1/17th (0.059) of the electrical conductivity of bulk silver. In some examples, the structure 80A, 80B formed of the second material exhibits an electrical conductivity of about 1/10th (0.10) ten percent of the electrical conductivity of bulk silver.

In some examples, device 30 comprises a controlled temperature environment in which the temperature of the first material, fluid agents, second material, and/or receiving surface 42 can be maintained with a selectable range before, after, during formation of the first layers 72 of the first material, formation of the second layers 104 of the second material, etc. In some examples, during formation of the first layers 72, the dispenser 58 is not moved in and out of this temperature-controlled environment during fusing or other application of energy during formation of a 3D object. In some examples, the receiving surface 42 and any at least partially formed 3D object thereon is not moved in/out of this temperature-controlled environment during the formation of the 3D object.

In some examples, the controlled temperature environment includes preventing the printed layers 104 of second material from exceeding a melting point (e.g. about 180° C.) of the dried second material (e.g. silver nanoparticles) and from being below a recrystallization point (e.g. about 140° C.) of the first build material forming layers 72. This temperature range is maintained while performing activities such as drying the dispensed second fluid agent (on the underlying fused layer 72) to produce the remaining layer 104 of second material. Of course, various second materials may exhibit different melting points and different build materials may exhibit different recrystallization points.

In some examples, the device 30 may comprise or be part of an inert atmospheric environment or other controlled atmosphere environment atmosphere. For instance, in some examples in which a non-metal conductive material is used as a first or second material, the atmospheric environment may comprise a Nitrogen atmospheric environment.

After formation of the structures 80A, 80B, and as shown in at least FIG. 4, the material coater 50 deposits a coat of first material as a layer 134 on top of the preceding first layer 72, with the first material flowing around the structures 80A, 80B to surround the structures 80A, 80B. In this way, the structures 80A, 80B may sometimes be referred to as islands or peninsulas about which the first material flows. If the height (H3 in FIG. 3A-3B) of the structures 80A, 80B is the same as or greater than a height (H1) of the layer 134, then little or no first material would be present on top of the structures 80A, 80B.

In this way, the structures 80A, 80B act as replacement voxels in layer 134 in the sense that the second material of the structures 80A, 80B acts to replace voxels that would otherwise be formed of the first material which forms layers 72 and the rest of layer 134.

As shown in FIG. 5, upon repeating the formation of another second structure 148A, 148B at the second selected locations 81A, 81B (at which structures 80A, 80B were formed), another first layer 144 is formed to surround structures 148A, 148B such that structures 148A, 148B of the second material act as replacement voxel(s) for first material in layer 144.

As further shown in FIG. 5, the second structures 80A and 148A combine to form a single monolithic structure 150A of second material and the second structures 80B and 148B combine to form a single monolithic structure 150B of second material. In some examples, structures 150A, 150B have a height H4, which corresponds to a two-voxel height.

In some examples, the second structure(s) 80A, 80B formed by the second layers 104 of the second material is separate from and independent of the first structure formed by the first layers 72, 134, and 144 of first material. However, it will be understood that in some examples, second structure(s) 80A, 80B and the first structure of layers 72, 134, 144 may become at least mechanically connected after their respective formation.

While in the above examples each structure 80A, 80B, 148A, 148B is described as replacing a single voxel of the respective layers 134, 144, it will be understood that in some examples, each structure 80A, 80B, 148A, 148B replaces a group of adjacent voxels. As such, each structure 80A, 80B, 148A, 148B may sometimes be referred to as effecting group voxel replacement.

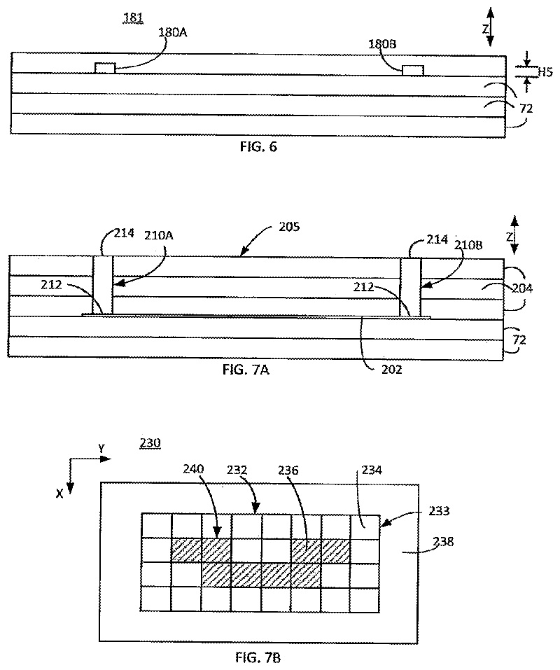

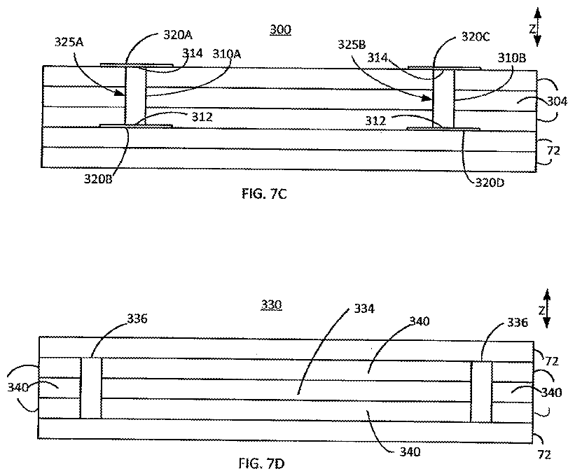

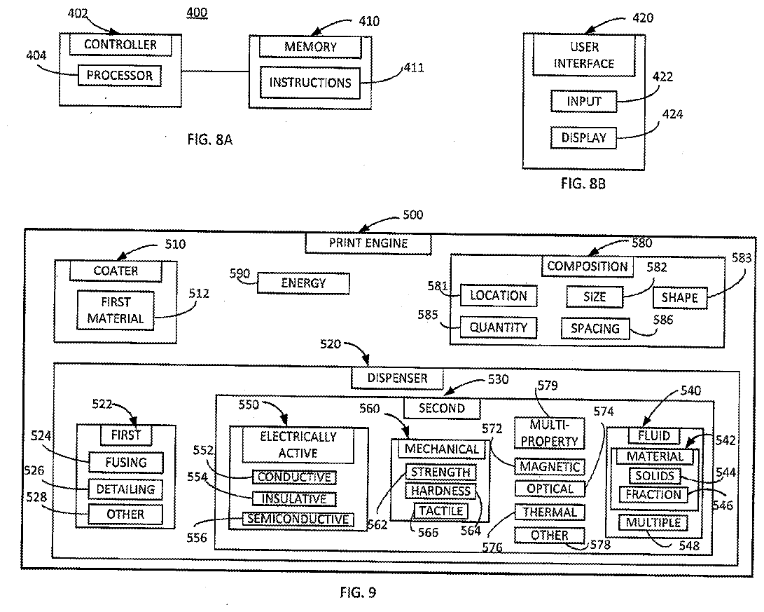

As later shown in FIG. 6 at 181, in some examples a second structure 180A, 180B is formed having a height H5 less than a height H1 of one of the first layers 72. When the first layer 72 has a height H1 the same as the height of a voxel, then the second structure 180A, 180B with height H5 may sometimes be referred to as a partial height voxel. In some examples, a series of such partial height voxels may be employed in a desired pattern to construct electrically conductive traces extending in an axis or plane perpendicular to an electronic via, such as later shown in FIG. 7B.

FIG. 7A is a sectional view schematically representing at least a portion of an example 3D object including at least an embedded structure of at least one second material. In some examples, the at least partially formed 3D object 200 in FIG. 7A comprises at least some of substantially the same features as 3D object 140 in FIG. 5, except further comprising a conductive element 202. For instance, the 3D object 200 comprises a pair of spaced apart single conductive elements 210A, 210B which are substantially similar to structures 150A, 150B in FIG. 5. In some examples, the elements 210A, 210B may function as electronic vias. Accordingly, upon a conductive element(s) 202 being embedded or otherwise formed within first layers 204, the single electronic vias 210A, 210B provide an electronic pathway to an external surface 205 or another conductive element(s) 202. In some examples, the conductive element(s) 202 may comprise circuitry or circuitry component(s). For instance, in some examples the conductive element(s) 202 may comprise 2D printed electronic circuits, 3D printed circuit boards, embedded antennas, RFIDs, microelectromechanical (MEM) systems, low-power electronic devices, etc.

In some examples, a top surface 214 of the respective structures 210A, 210B may be exposed at or as an external surface 205 of the 3D object (or a portion of the 3D object) to enable operation as an electrical pad for low resistance electrical connection to external electrically conductive components, circuits, devices, etc.

In some examples, an electrically conductive trace and/or 2D printed electronic circuit as represented as 202 in FIG. 7A may take the form shown in FIG. 7B.

FIG. 7B is a diagram including a top view schematically representing an example pattern of voxels of an example 3D object. As shown in FIG. 7B, the at least partially formed 3D object 232 comprises a group 233 of first selected portions 234. The first selected portions 234 correspond to a layer of first material which has received a first fluid agent and been fused via application of energy. Some of the first selected portions 234 comprises second selected portions 236 (represented via cross-hatching) at which a structure 240 was formed from a second material in the manner described herein, such as in association with at least FIGS. 1A-7B and 8-10. The region identified via reference 238 corresponds to a layer of first material which has not received a first fluid agent and has not been fused. This region 238 surrounding the shape and size of the 3D object 232 is later separated from the intended 3D object 232.

Accordingly, in some examples, the structure 240 in FIG. 7B defined by the second selected locations 236 corresponds to the structure 202 in the at least partially formed 3D object 200 in FIG. 7A.

FIG. 7C is a sectional view schematically representing an at least partially formed example 3D object 300. In some examples, the 3D object 300 comprises at least some of substantially the same features and attributes as the 3D objects as described in association with at least FIGS. 1A-7B and FIGS. 8A-10. As shown in FIG. 7C, 3D object 300 includes first layers 72, 340 of a first material, such as a build material. 3D object 300 also includes structures 310A, 310B which are formed in a manner similar to structures 150A, 150B (FIGS. 2A-7A). In addition, 3D object includes structures 320A, 320B at opposite ends of structure 310A and structures 320C, 320D at opposite ends of structure 310B.

In some examples, the structures 310A, 310B may comprise a column of electrically insulative second material and the structures 320A, 320B and 320C, 320B may comprise an electrically conductive material such that each of the respective overall structures 325A, 325B comprise a capacitor. In such examples, prior to forming the electrically insulative structures 310A, 310B, a first electrically conductive pad 320B or 320D is formed (via a second fluid agent by dispenser 58) on the uppermost layer of the layers 72 of the first material. In a manner similar to that shown in at least FIGS. 1A-5, the electrically insulative structures 310A, 310B are then formed on top of this first electrically conductive pad 320B or 320D on a layer-by-layer basis (FIGS. 2A-3B) along with accompanying first layers 340 (FIG. 4) on a layer-by-layer basis. Next, an opposite second electrically conductive pad 320A and 320C is formed on top of a second end of the respective electrically insulative structures 310A, 310B. The exposed conductive pads 320A, 320C may be electrically connected to additional electrically active components, and additional layers of the first material and/or other circuitry elements may be formed as part of 3D object 300.

FIG. 7D is a sectional view schematically representing an at least partially formed example 3D object 330. In some examples, the 3D object 330 comprises at least some of substantially the same features and attributes as the 3D objects as described in association with at least FIGS. 1A-7C and FIGS. 8A-10. However, in the example of FIG. 7D, a structure 334 extends generally along the x-y plane instead of a structure 310A, 310B extending in the z-axis as in FIG. 7C. In some examples, the structure 334 comprises a second material which may have different properties (e.g. electrical, mechanical, magnetic, optical, thermal, and/or other, etc.) than the surrounding first material of first layers 72, 340 of a first material.

Similarly, in some examples, structures 336 are formed at opposite ends of structure 334 with structures 336 also being made of a second material, which may have similar or different properties than the second material used to form structure 334. For instance, continuing the examples of electrically active second materials, the structure 334 may comprise an electrically insulative material and the structures 336 may comprise an electrically conductive material such that the overall structure 350 exhibits capacitive functionality.

Some specific examples have been provided in which the second material comprises an electrically active material, such as an electrically conductive material or an electrically insulative material. However, as noted above and elsewhere, voxel replacement of the first material in a 3D object may sometimes be implemented via a second material (via a second fluid agent) exhibiting at least one other property (e.g. magnetic, thermal, optical, etc.) whether or not the second material exhibits electrically active properties, as further described later in association with at least FIG. 9.

It will be understood that in some examples, the various structures of a second material(s), which replace a first material, can extend within a 3D object at a variety of angles, configurations, etc. and are not strictly limited to the orientations, sizes, shapes shown in FIGS. 1-7D. Moreover, multiple, independent structures formed via voxel replacement using a second material(s) as described herein may be incorporated into a 3D object in which the multiple, independent structures are spaced apart from each other within the 3D object and may be unrelated from each other functionally while all such multiple, independent structures form part of the same 3D object.

In at least some examples, the additive manufacture manufacturing process is performed in association with device 30 (FIG. 1A) without subtractive manufacturing processes, such as machining, etching, etc.

In at least some examples, the additive manufacture manufacturing process is performed in association with device 30 (FIG. 1A) without extruding the first material to form first layers 72.

In at least some examples, the additive manufacture manufacturing process is performed in association with device 30 (FIG. 1A) without UV curing.

In at least some examples, the additive manufacture manufacturing process is performed in association with device 30 (FIG. 1A) without a mask or stencil.

In at least some examples, the additive manufacture manufacturing process is performed in association with device 30 (FIG. 1A) with a single dispenser to dispense both a first fluid agent used to form layers of first material and to dispense a second fluid agent comprising a second material.

In some examples, the entire additively formed 3D object is solid, while in some examples, just portions of the 3D object are solid. In some examples, the entire 3D object or portions of the 3D object are hollow, i.e. formed as wall(s) which together define a hollow interior space.

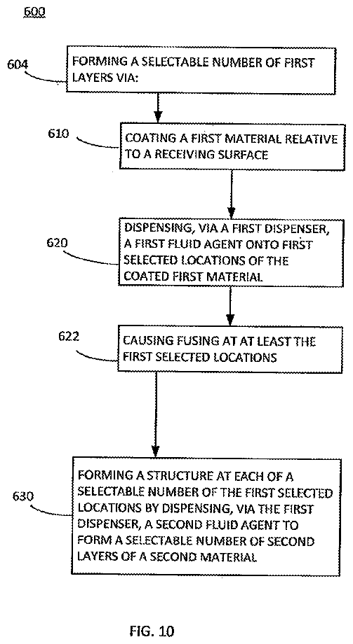

FIG. 8A is a block diagram schematically representing a control portion 400, according to one example of the present disclosure. In some examples, control portion 400 provides one example implementation of a control portion forming a part of, implementing, and/or managing any one of devices, material coaters, fluid dispensers, energy source, instructions, engines, functions, parameters, and/or methods, as represented throughout the present disclosure in association with FIGS. 1A-7 and 9-10.

In some examples, control portion 400 includes a controller 402 and a memory 410. In general terms, controller 402 of control portion 400 comprises at least one processor 404 and associated memories. The controller 402 is electrically couplable to, and in communication with, memory 410 to generate control signals to direct operation of at least some the devices, material coater, agent supply, fluid dispenser, energy source, instructions, engines, functions, parameters, and/or methods, as represented throughout the present disclosure. In some examples, these generated control signals include, but are not limited to, employing instructions 411 stored in memory 410 to at least direct and manage additive manufacturing of 3D objects in the manner described in at least some examples of the present disclosure.

In response to or based upon commands received via a user interface (e.g. user interface 420 in FIG. 8B) and/or via machine readable instructions, controller 402 generates control signals to implement additive manufacturing of a 3D object in accordance with at least some of the examples of the present disclosure. In some examples, controller 402 is embodied in a general purpose computing device while in some examples, controller 402 is incorporated into or associated with at least some of the associated devices, material coater, fluid dispensers, energy source, instructions, engines, functions, parameters, and/or methods etc. described throughout the present disclosure.

For purposes of this application, in reference to the controller 402, the term “processor” shall mean a presently developed or future developed processor (or processing resources) that executes sequences of machine readable instructions contained in a memory. In some examples, execution of the sequences of machine readable instructions, such as those provided via memory 410 of control portion 400 cause the processor to perform actions, such as operating controller 402 to implement additive manufacturing of 3D objects as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 410. In some examples, memory 410 comprises a computer readable tangible medium providing non-volatile storage of the machine readable instructions executable by a process of controller 402. In other examples, hard wired circuitry may be used in place of or in combination with machine readable instructions to implement the functions described. For example, controller 402 may be embodied as part of at least one application-specific integrated circuit (ASIC). In at least some examples, the controller 402 is not limited to any specific combination of hardware circuitry and machine readable instructions, nor limited to any particular source for the machine readable instructions executed by the controller 402.

In some examples, control portion 400 is entirely implemented within or by a stand-alone device, which has at least some of substantially the same features and attributes as device 30 as previously described in association with at least FIGS. 1A-9. In some examples, the control portion 400 is partially implemented in the device 30 and partially implemented in a computing resource separate from, and independent of, the device 30 but in communication with the device 30.

In some examples, control portion 400 includes, and/or is in communication with, a user interface 420 as shown in FIG. 8B. In some examples, user interface 420 comprises a user interface or other display that provides for the simultaneous display, activation, and/or operation of at least some of the devices, material coaters, agent supply, fluid dispenser, energy source, instructions, engines, functions, parameters, and/or methods, as described in association with FIGS. 1A-9. In some examples, at least some portions or aspects of the user interface 420 are provided via a graphical user interface (GUI), and may comprise a display 424 and input 422.

FIG. 9 is a block diagram schematically representing a print engine 500, according to one example of the present disclosure. In some examples, print engine 500 provides one example implementation of instructions 411 in control portion 400 in FIG. 8A suitable for operation of device 30. In some examples, print engine 500 comprises at least some of substantially the same features and attributes of instructions 411 and/or control portion 400 generally in association with FIG. 8A.

As shown in FIG. 9, in some examples, print engine 500 comprises a coater engine 510, a dispenser engine 520, a composition engine 580, and/or an energy source engine 590. In some examples, the print engine 500 directs and manages additive manufacturing of a 3D object, including coating materials and/or dispensing materials and fluids relative to a receiving surface to additively form a three-dimensional (3D) object.

In general terms, the coater engine 510 enables the selection of materials to be deposited, such as coating a first material onto a receiving surface and/or previously formed layers of a partially formed 3D object.

In some examples, the coater engine 510 comprises a material parameter 512. Via the material parameter 512, the print engine 500 specifies which material(s) and the quantity of such materials which can be used to additively form a body of the 3D object. In some examples, such materials may sometimes be referred to as a build material. In some examples, such materials may be referred to as a first material. In some examples, these materials are deposited via material coater 50 of device 30 (FIG. 1A).

The material controlled via material parameter 512 of coater engine 510 may comprise polymers, ceramics, etc. having sufficient strength, formability, toughness, etc. for the intended use of the 3D object with at least some example materials being previously described in association with at least FIG. 1A.

In some examples, the dispenser engine 520 may specify which agents are to be selectively deposited onto a previously deposited layer of material and/or in association with other agents. In some examples, such agents are deposited via fluid dispenser 58 (FIG. 1A). In some examples, the dispenser engine 520 comprises a first fluid agent function 522 and a second fluid agent function 530.

In some examples, the first fluid agent function 522 controls dispensing via dispenser 58 of a first fluid agent (62 in FIG. 1A) used as part of forming first layers 72 (FIGS. 1A-7D) of a build material in additively manufacturing a 3D object. In some examples, the first fluid agent function 522 comprises a fusing parameter 524, a detailing parameter 526, and other parameter 528.

In some examples, the fusing parameter 524 controls dispensing of a fusing agent which may facilitate fusing of the coated first materials (e.g. a build material) into a monolithic structure, while the detailing parameter 526 controls dispensing of a detailing agent to complement fusing of the coated build materials. In some examples, other agents or additional agents are dispensed selectively as controlled via other parameter 528.

In some examples, the second fluid agent function 530 controls dispensing of a second fluid agent (64 in FIG. 1A). In some examples, and as more fully described below, the second fluid agent 64 comprises a second material different than the first material controlled via first material parameter 512 of coater engine 510.

In some examples, the second fluid agent function 530 comprises a fluid composition parameter 540 which governs the composition of the second fluid agent 64. In some examples, the fluid composition parameter 540 comprises a second materials parameter 542, which controls the type(s) of second material in the second fluid agent 64. For instance, the second fluid agent may comprise a single second material or may comprise multiple different second materials per multiple parameter 548 with each different second material having different properties (e.g. electrical, mechanical, etc.) as further described below. In some examples, the second material may comprise the same material as the first material. In some examples, the second material may comprise the same material as the first material in the manner previously described in association with at least FIGS. 1A-3B in which the first material may act as a fusing agent (and not primarily as an electrically conductive material) and when dispensed as a second material, acts primarily as an electrically conductive element.

In some examples, the materials parameter 542 may control a fraction (546) of solids (544) relative to the overall volume of second fluid agent dispensed. Accordingly, this control may indirectly determine a volume of ink flux (e.g. fluid components) in the overall volume of dispensed second fluid agent.

In some examples, the properties of the second fluid agent may be controlled via an electrically active property parameter 550. For instance, via parameter 550, the second material in the second fluid agent may comprise electrically conductive properties (552), an electrically insulative properties (554), or semi-conductive properties (556). Such material properties may be used to form various circuitry elements within the 3D object.

In some examples, the properties of the second fluid agent may be controlled via a mechanical property parameter 560. For instance, via parameter 560, the second material in the second fluid agent may comprise a strength property 562, a hardness property 564, and/or a tactile property 566. It will be understood that other, different mechanical properties also may be selected and/or controlled via mechanical property parameter 560. Accordingly, parameters 562, 564, 566 do not exclusively define the full range of mechanical properties which may be selected and/or controlled via mechanical property parameter 560.

In some examples, the properties of the second fluid agent may be controlled via additional property parameters, such as a magnetic parameter 572, an optical parameter 574, thermal parameter 576, and other properties parameter 578. Via such parameters, the second fluid agent function 530 may select and/or control the extent to which the second material exhibits various magnetic, optical, thermal, and/or properties.

In some examples, the second fluid agent function 530 selects or implements a single property of the dispensed second material. However, in some examples, via a multi-property parameter 579, the second fluid agent function 530 may select or implement multiple different properties for the deposited second materials. In some examples, the multiple different properties may be implemented at any particular selected voxel. In some examples, just one selectable property is implemented for a single voxel (or group of voxels), with other selectable properties being implemented at other single voxels (or groups of voxels).

Accordingly, in some examples, the second material dispensed via the second fluid agent comprises at least one material having properties (e.g. structural, strength, optical, magnetic, hardness, thermal, electrical, etc.) other than the properties of the first material, as previously noted in association with at least FIG. 1A.

In some examples, any one of the properties (e.g. 552, 554, 556, 562, 564, 566, 572, 574, 576, 578 in FIG. 9) selectable via second fluid agent function 530 also may be implemented via the first fluid agent in association with the other parameter 528 of first fluid function 522 and/or also may be already incorporated with the first material deposited as one of the first layers (e.g. 72) via the coater 50 (FIG. 1A). Such implementation may complement the various properties (e.g. 552, 554, 556, 562, 564, 566, 572, 574, 576, 578 in FIG. 9) implemented within the second material deposited via second fluid agent function 530 (FIG. 9) of dispenser 58 (FIG. 1A).

It will be understood that in some examples the coater engine 510 and dispenser engine 520 are not limited to specifying the types of materials, agents, etc. associated with parameters (e.g. 552, 554, 556, 562, 564, 566, 572, 574, 576, 578) shown in FIG. 9, but instead may specify any type of material, agent, etc. conducive to additively manufacturing a 3D object, with such type of materials, agents, etc. depending on the size, type, shape, use, etc. of the 3D object, and depending on the particular type of method used to perform the additive manufacturing of the 3D object.

With respect to the various fluid agents and/or various properties controllable via dispenser engine 520, it will be understood that dispenser 58 (FIG. 1A) of device 30 may be configured with correspondingly separate reservoirs, delivery channels, etc. to enable such separate fluid agents and/or additives to be selectively dispensed as desired during the additive manufacturing of the 3D object. Similarly, to the extent that different first materials are used per parameter 512 of coater engine 510, then each different material may be contained in separate reservoir until deposited via coater 50 (FIG. 1A).

In general terms, the composition engine 540 of print engine 500 enables the selection of attributes by which the selected fluid agents are deposited via dispenser engine 520. For instance, in some examples the composition engine 540 comprises a location parameter 542, a size parameter 544, a shape parameter 546, a quantity parameter 548, and a spacing parameter 550. The location parameter 542 can specify a location at which the various agents and/or a structural features of the 3D object is located. For instance, the location parameter 542 can specify a location at which a color agent is to deposited to cause fusing (e.g. via melting, via sintering, etc.) of a layer of material. Meanwhile, the size parameter 544 can specify a size of the area over which the particular agent (e.g. color, detailing, etc.) is deposited. The size can be specified as an absolute quantity or as a relative quantity, i.e. a size relative to a size or volume of the surrounding material not receiving a particular agent.

In some examples, the shape parameter 546 enables specifying a shape over which a particular agent is deposited, which can be absolute or relative to the general shape of the 3D object. In some examples, the quantity parameter 548 enables specifying a quantity of locations at which a particular agent is deposited on a layer of material. In some examples, the spacing parameter 550 enables specifying a spacing between multiple locations at which a particular agent is deposited.

In general terms, the energy engine 590 of print engine 500 enables specifying various processing steps on the deposited materials and agents, such as applying energy to cause fusing, etc. of the deposited materials.

In some examples, the energy engine 590 may control an amount of time that energy from energy source (e.g. 55 in FIG. 1A) is emitted (i.e. irradiation) toward the material, agents, etc. on the receiving surface 42. In some examples, the energy source 55 may irradiate the material layer in a single flash or in multiple flashes. In some examples, the energy source 55 may remain stationary (i.e. static) or may be mobile. In either case, during such irradiation, the energy engine 590 controls the intensity, volume, and/or rate of irradiation. In some examples, energy engine 590 also controls operation of a second energy source 114 (FIG. 2B) in a manner as previously described in association with at least FIGS. 1A-2B.

FIG. 10 is a flow diagram schematically representing a method of manufacturing a 3D object, according to one example of the present disclosure. In some examples, method 600 is performed via at least some of the devices, material coaters, fluid dispensers, energy sources, instructions, engines, function, methods, etc. as previously described in association with at least FIGS. 1A-9. In some examples, method 600 is performed via at least some of the devices, material coaters, fluid dispensers, energy sources, instructions, engines, function, methods, etc. other than those previously described in association with at least FIGS. 1A-9. In particular, in some examples, method 600 is implemented via at least a print engine, such as print engine 500 in FIG. 9 and/or instructions 411 in FIG. 8A.

As shown in FIG. 10, at 604 method 600 comprises forming a selectable number of first layers via: coating a first material relative to a receiving surface (at 610); dispensing via a first dispenser, a first fluid agent onto first selected locations of the coated first material (at 620); and causing fusing at at least the first selected locations (at 622). At 630, method 600 comprises forming a structure at each of a selectable number of the first selected locations by dispensing, via the first dispenser, a second fluid agent to form a selectable number of second layers of a second material.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A 3D printer comprising:
a coater to coat a first material relative to a print bed to form a selectable number of first layers:
a dispenser to dispense a first fluid agent onto first selected locations of the first layers of the first material; and
a first energy source to cause fusing at least at the first selected locations,
wherein the dispenser is to dispense a second fluid agent including a second material to form a selectable number of second layers of the second material at second selected locations on top of the selectable number of first layers, wherein each second selected location comprises at least some of the fused first selected locations.

2. The 3D printer of claim 1, wherein the selectable number of second layers has at least one of:
a first height substantially equal to a height of one first layer; and
a second height less than a height of one first layer.

3. The 3D printer of claim 1, wherein after formation of the selectable number of second layers of the second material at the second selected locations, the coater is to form one layer of the first material at the fused first selected locations which exclude the second selected locations.

4. The 3D printer of claim 3, repeating cycles of:
the dispenser to dispense the second fluid agent to form the selectable number of second layers of the second material on top of the previously formed second material at the second selected locations; and
the coater to form one layer of the first material at the fused first selected locations which exclude the second selected locations.

5. The 3D printer of claim 1, the dispenser to dispense the second material as a second electrically active material to form a second electrically active structure at the second selected locations.

6. The 3D printer of claim 5, the coater to coat the first material, and the dispenser to dispense the first fluid agent, at a selectable number of the first selected locations within a selectable number of the first layers as a first electrically active material to form a first electrically active structure, which is electrically connected to the second electrically active structure.

7. The 3D printer of claim 1, wherein at least one material property of the second material is different than at least one material property of the first material, and wherein the at least one material property comprises at least one of:
an electrical property;
a mechanical property;
a magnetic property;
a thermal property; and
an optical property.

8. The 3D printer of claim 1, comprising:
a second energy source to apply energy preferentially to the second selected locations relative to other first selected locations to expedite drying the second material without overheating the other first selected locations.

9. The 3D printer of claim 8, wherein the dispenser is to dispense the second fluid agent including an optical absorption agent to facilitate preferential absorption of energy, applied by the second energy source, at the second selected locations.

10. An additive manufacturing device comprising:
a coater;
a dispenser;
a first energy source; and
a controller including a processing resource to execute machine readable instructions stored in a non-transitory medium to:
form a selectable number first layers of a first material via instructions to:
coat, via the coater, the first material relative to a receiving surface;
dispense, via the dispenser, a first fluid agent onto first selected voxels of the coated first material; and
apply the first energy source to cause fusing of the coated first material at the first selected voxels; and
dispense, via the dispenser, a second fluid agent including at least one second material to form a selectable number of second layers of the at least one second material at second selected voxels, which comprise some of the first selected voxels.

11. The device of claim 10, wherein a height of each second layer is at least one order of magnitude less than a height of each first layer.

12. The device of claim 10, wherein the at least one second material comprises a plurality of second materials, wherein each respective second material comprises at least one material property which differs from the material properties of the first material, and wherein the at least one material property comprises at least one of:
an electrical property;
a mechanical property;
a magnetic property;
a thermal property; and
an optical property.

13. A method of additively manufacturing a 3D object comprising:
forming a selectable number of first layers via:
coating a first material relative to a receiving surface;
dispensing, via a first dispenser, a first fluid agent onto first selected voxel locations of the coated first material; and
causing fusing at least the first selected voxel locations; and
forming a structure at each of a selectable number of the first selected voxel locations by dispensing, via the first dispenser, a second fluid agent including an electrically active second material to form a selectable number of second layers of the electrically active second material.

14. The method of claim 13, wherein the electrically active second material comprises at least one of:
an electrically conductive material;
an electrically insulative material; and
a semi-conductive material.

15. The method of claim 12, wherein the dispensing of the second fluid agent comprises dispensing the second fluid agent to form each respective second layer having a height substantially less than a height of each respective first layer, and
wherein the formed structure has a height equal to or greater than the height of each respective first layer.
